(19) United States
(12) Patent Application Publication
(10) Pub. No.: US 2021/0233556 A1
(43) Pub. Date: Jul. 29, 2021

(54) VOICE PROCESSING DEVICE, VOICE PROCESSING METHOD, AND RECORDING MEDIUM

(71) Applicant: Sony Corporation, Tokyo (JP)

(72) Inventor: Koso KASHIMA, Tokyo (JP)

(73) Assignee: Sony Corporation, Tokyo (JP)

(21) Appl. No.: 15/734,994

(22) PCT Filed: May 27, 2019
(86) PCT No.: PCT/JP2019/020970

§ 371 Date: Dec. 4, 2020

(30) Foreign Application Priority Data
Jun. 27, 2018 (JP) 2018-122506

(51) Int. Cl. G10L 25/78; G10L 15/08; G10L 15/02

(52) U.S. Cl. CPC G10L 25/78; G10L 2015/088; G10L 15/02; G10L 15/08

(57) ABSTRACT

A voice processing device includes a reception unit (30) configured to receive voices corresponding to a predetermined time length and information related to a trigger for starting a predetermined function corresponding to the voice, and a determination unit (51) configured to determine a voice to be used for executing the predetermined function among the voices corresponding to the predetermined time length in accordance with the information related to the trigger received by the reception unit (30).

### FIELD

The present disclosure relates to a voice processing device, a voice processing method, and a recording medium. Specifically, the present disclosure relates to voice recognition processing for an utterance received from a user.

### BACKGROUND

With widespread use of smartphones and smart speakers, voice recognition techniques for responding to an utterance received from a user have been widely used. In such voice recognition techniques, a wake word as a trigger for starting voice recognition is set in advance, and in a case in which it is determined that the user utters the wake word, voice recognition is started.

As a technique related to voice recognition, there is known a technique for dynamically setting a wake word to be uttered in accordance with a motion of a user to prevent user experience from being impaired due to utterance of the wake word.

### CITATION LIST

### Patent Literature

Patent Literature 1: Japanese Patent Application Laid-open No. 2016-218852

### SUMMARY

### Technical Problem

However, there is room for improvement in the conventional technique described above. For example, in a case of performing voice recognition processing using the wake word, the user speaks to an appliance that controls voice recognition on the assumption that the user utters the wake word first. Thus, for example, in a case in which the user inputs a certain utterance while forgetting to say the wake word, voice recognition is not started, and the user should say the wake word and content of the utterance again. This fact causes the user to waste time and effort, and usability may be deteriorated.

Accordingly, the present disclosure provides a voice processing device, a voice processing method, and a recording medium that can improve usability related to voice recognition.

### Solution to Problem

To solve the problem described above, a voice processing device includes: a reception unit configured to receive voices corresponding to a predetermined time length and information related to a trigger for starting a predetermined function corresponding to the voice; and a determination unit configured to determine a voice to be used for executing the predetermined function among the voices corresponding to the predetermined time length in accordance with the information related to the trigger that is received by the reception unit.

### Advantageous Effects of Invention

With the voice processing device, the voice processing method, and the recording medium according to the present disclosure, usability related to voice recognition can be improved. The effects described herein are not limitations, and any of the effects described herein may be employed.

### BRIEF DESCRIPTION OF DRAWINGS

FIG. 1 is a diagram illustrating an outline of information processing according to a first embodiment of the present disclosure.

FIG. 2 is a diagram for explaining utterance extraction processing according to the first embodiment of the present disclosure.

FIG. 3 is a diagram illustrating a configuration example of a smart speaker according to the first embodiment of the present disclosure.

FIG. 4 is a diagram illustrating an example of utterance data according to the first embodiment of the present disclosure.

FIG. 5 is a diagram illustrating an example of combination data according to the first embodiment of the present disclosure.

FIG. 6 is a diagram illustrating an example of wake word data according to the first embodiment of the present disclosure.

FIG. 7 is a diagram (1) illustrating an example of interaction processing according to the first embodiment of the present disclosure.

FIG. 8 is a diagram (2) illustrating an example of interaction processing according to the first embodiment of the present disclosure.

FIG. 9 is a diagram (3) illustrating an example of interaction processing according to the first embodiment of the present disclosure.

FIG. 10 is a diagram (4) illustrating an example of interaction processing according to the first embodiment of the present disclosure.

FIG. 11 is a diagram (5) illustrating an example of interaction processing according to the first embodiment of the present disclosure.

FIG. 12 is a flowchart (1) illustrating a processing procedure according to the first embodiment of the present disclosure.

FIG. 13 is a flowchart (2) illustrating a processing procedure according to the first embodiment of the present disclosure.

FIG. 14 is a diagram illustrating a configuration example of a voice processing system according to a second embodiment of the present disclosure.

FIG. 15 is a diagram illustrating a configuration example of a voice processing system according to a third embodiment of the present disclosure.

FIG. 16 is a hardware configuration diagram illustrating an example of a computer that implements a function of a smart speaker.

### DESCRIPTION OF EMBODIMENTS

The following describes embodiments of the present disclosure in detail based on the drawings. In the following embodiments, the same portion is denoted by the same reference numeral, and redundant description will not be repeated.

### 1. First Embodiment

1-1. Outline of Information Processing According to First Embodiment

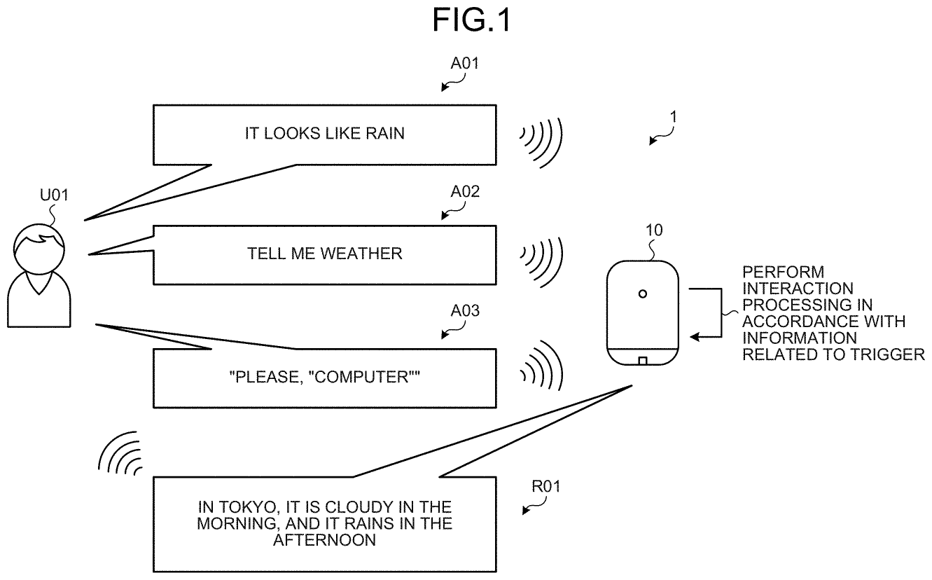

FIG. 1 is a diagram illustrating an outline of information processing according to a first embodiment of the present disclosure. The information processing according to the first embodiment of the present disclosure is performed by a voice processing system 1 illustrated in FIG. 1. As illustrated in FIG. 1, the voice processing system 1 includes a smart speaker 10.

The smart speaker 10 is an example of a voice processing device according to the present disclosure. The smart speaker 10 is an appliance that interacts with a user, and performs various kinds of information processing such as voice recognition and a response. Alternatively, the smart speaker 10 may perform voice processing according to the present disclosure cooperating with a server device connected thereto via a network. In this case, the smart speaker 10 functions as an interface that mainly performs interaction processing with the user such as processing of collecting utterances of the user, processing of transmitting collected utterances to the server device, and processing of outputting an answer transmitted from the server device. An example of performing voice processing according to the present disclosure with such a configuration will be described in a second embodiment and the following description in detail. In the first embodiment, described is an example in which the voice processing device according to the present disclosure is the smart speaker 10, but the voice processing device may also be a smartphone, a tablet terminal, and the like. In this case, the smartphone and the tablet terminal exhibit a voice processing function according to the present disclosure by executing a computer program (application) having the same function as that of the smart speaker 10. The voice processing device (that is, the voice processing function according to the present disclosure) may be implemented by a wearable device such as a watch-type terminal or a spectacle-type terminal in addition to the smartphone and the tablet terminal. The voice processing device may also be implemented by various smart appliances having the information processing function. For example, the voice processing device may be a smart household appliance such as a television, an air conditioner, and a refrigerator, a smart vehicle such as an automobile, a drone, a household robot, and the like.

In the example of FIG. 1, the smart speaker 10 is installed in a house where a user U01, as an example of a user who uses the smart speaker 10, lives in. In the following description, in a case in which the user U01 and others are not required to be distinguished from each other, the users are collectively and simply referred to as a “user”. In the first embodiment, the smart speaker 10 performs response processing for collected voices. For example, the smart speaker 10 recognizes a question put by the user U01, and output an answer to the question by voice. Specifically, the smart speaker 10 generates a response to the question put by the user U01, and retrieves a tune requested by the user U01 and performs control processing for causing the smart speaker 10 to output a retrieved voice.

Various known techniques may be used for voice recognition processing, voice response processing, and the like performed by the smart speaker 10. For example, the smart speaker 10 may include various sensors not only for collecting voices but also for acquiring various kinds of other information. For example, the smart speaker 10 may include a camera for acquiring information in space, an illuminance sensor that detects illuminance, a gyro sensor that detects inclination, an infrared sensor that detects an object, and the like in addition to a microphone.

In a case of causing the smart speaker 10 to perform voice recognition and response processing as described above, the user U01 is required to give a certain trigger for causing a function to be executed. For example, before uttering a request or a question, the user U01 is required to give a certain trigger such as uttering a specific word (hereinafter, referred to as a “wake word”) for causing an interaction function (hereinafter, referred to as an “interaction system”) of the smart speaker 10 to start, or gazing at a camera included in the smart speaker 10. When receiving a question from the user after the user utters the wake word, the smart speaker 10 outputs an answer to the question by voice. In this way, the smart speaker 10 is not required to start the interaction system until the wake word is recognized, so that a processing load can be reduced. Additionally, the user U01 can prevent a situation in which an unnecessary answer is output from the smart speaker 10 when the user U01 does not need a response.

However, the conventional processing described above may deteriorate usability in some cases. For example, in a case of making a certain request to the smart speaker 10, the user U01 should carry out a procedure of interrupting a conversation with surrounding people that has been continued, uttering the wake word, and making a question thereafter. In a case in which the user U01 forgot to say the wake word, the user U01 should say the wake word and the entire sentence of the request again. In this way, in the conventional processing, a voice response function cannot be flexibly used, and usability may be deteriorated.

Thus, the smart speaker 10 according to the present disclosure solves the problem of the related art by the information processing described below. Specifically, the smart speaker 10 determines a voice to be used for executing the function among voices corresponding to a certain time length based on information related to the wake word (for example, an attribute that is set to the wake word in advance). By way of example, in a case in which the user U01 utters the wake word after making an utterance of a request or a question, the smart speaker 10 determines whether the wake word has an attribute of “performing response processing using a voice that is uttered before the wake word”. In a case of determining that the wake word has the attribute of “performing response processing using a voice that is uttered before the wake word”, the smart speaker 10 determines that the voice that is uttered by the user before the wake word is a voice to be used for response processing. Due to this, the smart speaker 10 can generate a response for coping with a question or a request by going back to the voice that is uttered by the user before the wake word. The user U01 is not required to say the wake word again even in a case in which the user U01 forgot to say the wake word, so that the user U01 can use response processing performed by the smart speaker 10 without stress. The following describes an outline of the voice processing according to the present disclosure along a procedure with reference to FIG. 1.

As illustrated in FIG. 1, the smart speaker 10 collects daily conversations of the user U01. At this point, the smart speaker 10 temporarily stores collected voices corresponding to a predetermined time length (for example, one minute). That is, the smart speaker 10 repeatedly accumulates and deletes the collected voices by buffering the collected voices.

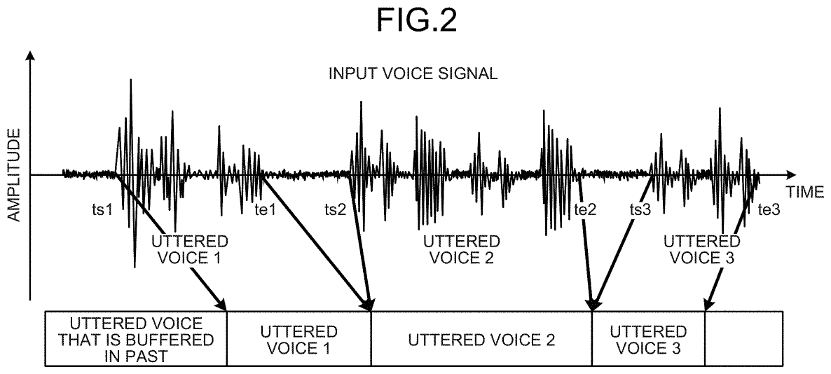

At this point, the smart speaker 10 may perform processing of detecting an utterance from among the collected voices. The following describes about this point with reference to FIG. 2. FIG. 2 is a diagram for explaining utterance extraction processing according to the first embodiment of the present disclosure. As illustrated in FIG. 2, by recording only a voice (for example, an utterance of the user) that is assumed to be effective for executing a function such as response processing, the smart speaker 10 can efficiently use a storage region (what is called a buffer memory) for buffering voices.

For example, regarding amplitude in which a voice signal exceeds a certain level, the smart speaker 10 determines a starting end of an utterance section when a zero crossing rate exceeds a certain number, and determines a terminal end when a value becomes equal to or smaller than a certain value to extract the utterance section. The smart speaker 10 then extracts only the utterance section, and buffers the voices from which a silent section is removed.

In the example illustrated in FIG. 2, the smart speaker 10 detects a starting end time ts1, and detects a terminal end time te1 thereafter to extract an uttered voice 1. Similarly, the smart speaker 10 detects a starting end time ts2, and detects a terminal end time te2 thereafter to extract an uttered voice 2. The smart speaker 10 detects a starting end time ts3, and detects a terminal end time te3 thereafter to extract an uttered voice 3. The smart speaker 10 then deletes a silent section before the uttered voice 1, a silent section between the uttered voice 1 and the uttered voice 2, and a silent section between the uttered voice 2 and the uttered voice 3, and buffers the uttered voice 1, the uttered voice 2, and the uttered voice 3. Due to this, the smart speaker 10 can efficiently use the buffer memory.

At this point, the smart speaker 10 may store identification information and the like for identifying the user who makes the utterance in association with the utterance by using a known technique. In a case in which an amount of free space of the buffer memory becomes smaller than a predetermined threshold, the smart speaker 10 deletes an old utterance to secure the free space, and saves a new voice. The smart speaker 10 may directly buffer the collected voices without performing processing of extracting the utterance.

In the example of FIG. 1, the smart speaker 10 is assumed to buffer a voice A01 of “it looks like rain” and a voice A02 of “tell me weather” among utterances of the user U01.

Additionally, the smart speaker 10 performs processing of detecting a trigger for starting a predetermined function corresponding to the voice while continuing buffering of the voice. Specifically, the smart speaker 10 detects whether the wake word is included in the collected voices. In the example of FIG. 1, the wake word set to the smart speaker 10 is assumed to be a “computer”.

In a case of collecting the voice such as a voice A03 of “please, computer”, the smart speaker 10 detects “computer” included in the voice A03 as the wake word. By being triggered by detection of the wake word, the smart speaker 10 starts a predetermined function (in the example of FIG. 1, what is called an interaction processing function of outputting a response to an interaction of the user U01). Additionally, in a case of detecting the wake word, the smart speaker 10 determines the utterance to be used for a response in accordance with the wake word, and generates the response to the utterance. That is, the smart speaker 10 performs interaction processing in accordance with information related to the received voice and the trigger.

Specifically, the smart speaker 10 determines an attribute to be set in accordance with the wake word uttered by the user U01, or a combination of the wake word and the voice that is uttered before or after the wake word. The attribute of the wake word according to the present disclosure means setting information for separating cases of timing of the utterance to be used for processing such as “to perform processing by using the voice that is uttered before the wake word in a case of detecting the wake word” or “to perform processing by using the voice that is uttered after the wake word in a case of detecting the wake word”. For example, in a case in which the wake word uttered by the user U01 has the attribute of “to perform processing by using the voice that is uttered before the wake word in a case of detecting the wake word”, the smart speaker 10 determines to use the voice uttered before the wake word for response processing.

In the example of FIG. 1, it is assumed that the attribute of “to perform processing by using the voice that is uttered before the wake word in a case of detecting the wake word” (hereinafter, this attribute is referred to as a “previous voice”) is set to a combination of the voice of “please” and the wake word of “computer”. That is, in a case of recognizing the voice A03 of “please, computer”, the smart speaker 10 determines to use the utterance before the voice A03 for response processing. Specifically, the smart speaker 10 determines to use the voice A01 or the voice A02 buffered before the voice A03 for interaction processing. That is, the smart speaker 10 generates a response to the voice A01 or the voice A02, and makes a response to the user.

In the example of FIG. 1, as a result of semantic understanding processing for the voice A01 or the voice A02, the smart speaker 10 estimates a situation in which the user U01 demands to know the weather. The smart speaker 10 then refers to location information and the like of a present location, and performs processing of retrieving weather information on the Web to generate a response. Specifically, the smart speaker 10 generates and outputs a response voice R01 of “in Tokyo, it is cloudy in the morning, and it rains in the afternoon”. In a case in which information for generating a response is insufficient, the smart speaker 10 may appropriately make a response for compensating lack of information (for example, “please tell me the location, and the date and time of the weather you want to know”).

In this way, the smart speaker 10 according to the first embodiment receives the buffered voice corresponding to the predetermined time length, and the information related to the trigger (wake word and the like) for starting the predetermined function corresponding to the voice. The smart speaker 10 then determines the voice to be used for executing the predetermined function among the voices corresponding to the predetermined time length in accordance with the received information related to the trigger. For example, in accordance with the attribute of the trigger, the smart speaker 10 determines the voice that is collected before the trigger is recognized to be the voice used for executing the predetermined function. The smart speaker 10 controls execution of the predetermined function based on the determined voice. For example, the smart speaker 10 controls execution of the predetermined function corresponding to the voice that is collected before the trigger is detected (in the example of FIG. 1, a retrieval function of retrieving the weather, and an output function of outputting retrieved information).

As described above, the smart speaker 10 not only makes a response to the voice after the wake word, but also can make a flexible response corresponding to various situations such as immediately making a response corresponding to the voice before the wake word at the time of starting the interaction system by the wake word. In other words, the smart speaker 10 can perform response processing by going back to the buffered voice without a voice input from the user U01 and the like after the wake word is detected. Although details will be described later, the smart speaker 10 can also generate a response by combining the voice before the wake word is detected and the voice after the wake word is detected. Due to this, the smart speaker 10 can make an appropriate response to a casual question and the like uttered by the user U01 and the like during a conversation without causing the user U01 to say the question again after uttering the wake word, so that usability related to interaction processing can be improved.

1-2. Configuration of Voice Processing Device According to First Embodiment

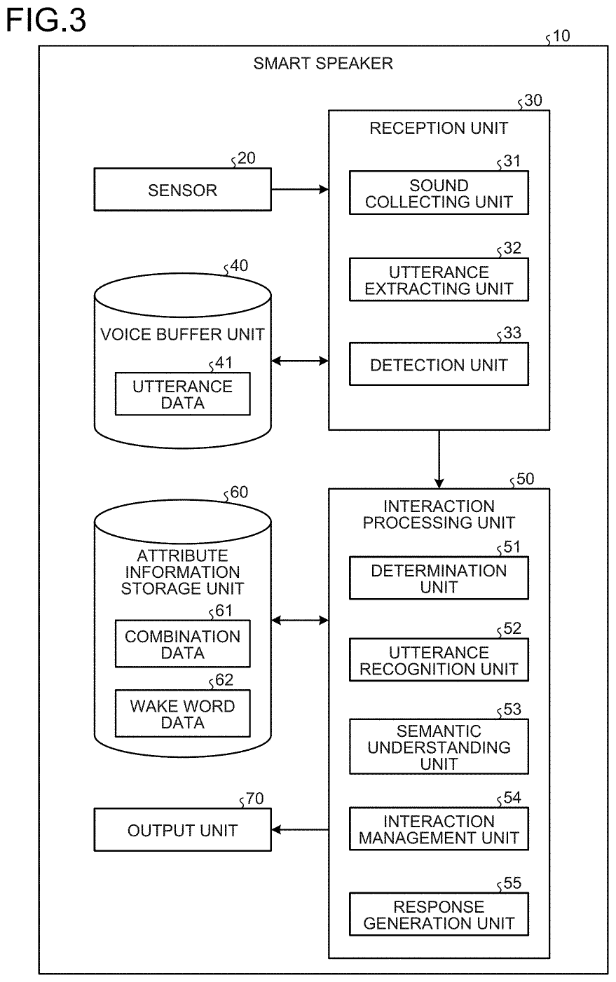

Next, the following describes a configuration of the smart speaker 10 as an example of the voice processing device that performs voice processing according to the first embodiment. FIG. 3 is a diagram illustrating a configuration example of the smart speaker 10 according to the first embodiment of the present disclosure.

As illustrated in FIG. 3, the smart speaker 10 includes processing units such as a reception unit 30 and an interaction processing unit 50. The reception unit 30 includes a sound collecting unit 31, an utterance extracting unit 32, and a detection unit 33. The interaction processing unit 50 includes a determination unit 51, an utterance recognition unit 52, a semantic understanding unit 53, an interaction management unit 54, and a response generation unit 55. Each of the processing units is, for example, implemented when a computer program (for example, a voice processing program recorded in the recording medium according to the present disclosure) stored in the smart speaker 10 is executed by a central processing unit (CPU), a micro processing unit (MPU), or the like by using a random access memory (RAM) or the like as a working area. Each of the processing units may also be implemented by an integrated circuit such as an application specific integrated circuit (ASIC) or a field programmable gate array (FPGA), for example.

The reception unit 30 receives the voice corresponding to the predetermined time length, and the trigger for starting the predetermined function corresponding to the voice. The voice corresponding to the predetermined time length is, for example, a voice stored in a voice buffer unit 40, an utterance of the user that is collected after the wake word is detected, and the like. The predetermined function is various kinds of information processing performed by the smart speaker 10. Specifically, the predetermined function is start, execution, stop, and the like of the interaction processing (interaction system) with the user performed by the smart speaker 10. The predetermined function includes various functions for implementing various kinds of information processing accompanied with processing of generating a response to the user (for example, Web retrieval processing for retrieving content of an answer, processing of retrieving a tune requested by the user and downloading the retrieved tune, and the like). Processing of the reception unit 30 is performed by the respective processing units, that is, the sound collecting unit 31, the utterance extracting unit 32, and the detection unit 33.

The sound collecting unit 31 collects the voices by controlling a sensor 20 included in the smart speaker 10. The sensor 20 is, for example, a microphone. The sensor 20 may also have a function of detecting various kinds of information related to a motion of the user such as orientation, inclination, movement, moving speed, and the like of a user's body. That is, the sensor 20 may also include a camera that images the user or a peripheral environment, an infrared sensor that senses presence of the user, and the like.

The sound collecting unit 31 collects the voices, and stores the collected voices in a storage unit. Specifically, the sound collecting unit 31 temporarily stores the collected voices in the voice buffer unit 40 as an example of the storage unit.

The sound collecting unit 31 may previously receive a setting about an amount of information of the voices to be stored in the voice buffer unit 40. For example, the sound collecting unit 31 receives, from the user, a setting of storing the voices corresponding to a certain time as a buffer. The sound collecting unit 31 then receives the setting of the amount of information of the voices to be stored in the voice buffer unit 40, and stores the voices collected in a range of the received setting in the voice buffer unit 40. Due to this, the sound collecting unit 31 can buffer the voices in a range of storage capacity desired by the user.

In a case of receiving a request for deleting the voice stored in the voice buffer unit 40, the sound collecting unit 31 may delete the voice stored in the voice buffer unit 40. For example, the user may desire to prevent past voices from being stored in the smart speaker 10 in view of privacy in some cases. In this case, after receiving an operation related to deletion of the buffered voice from the user, the smart speaker 10 deletes the buffered voice.

The utterance extracting unit 32 extracts an utterance portion uttered by the user from the voices corresponding to the predetermined time length. As described above, the utterance extracting unit 32 extracts the utterance portion by using a known technique related to voice section detection and the like. The utterance extracting unit 32 stores extracted utterance data in utterance data 41. That is, the reception unit 30 extracts, as the voice to be used for executing the predetermined function, the utterance portion uttered by the user from the voices corresponding to the predetermined time length, and receives the extracted utterance portion.

The utterance extracting unit 32 may also store the utterance and the identification information for identifying the user who has made the utterance in association with each other in the voice buffer unit 40. Due to this, the determination unit 51 (described later) is enabled to perform determination processing using user identification information such as using only an utterance of a user same as the user who uttered the wake word for processing, and not using an utterance of a user different from the user who uttered the wake word for processing.

The following describes the voice buffer unit 40 and the utterance data 41 according to the first embodiment. For example, the voice buffer unit 40 is implemented by a semiconductor memory element such as a RAM and a Flash Memory, a storage device such as a hard disk and an optical disc, or the like. The voice buffer unit 40 includes the utterance data 41 as a data table.

The utterance data 41 is a data table obtained by extracting only a voice that is estimated to be a voice related to the utterance of the user among the voices buffered in the voice buffer unit 40. That is, the reception unit 30 collects the voices, detects the utterance from the collected voices, and stores the detected utterance in the utterance data 41 in the voice buffer unit 40.

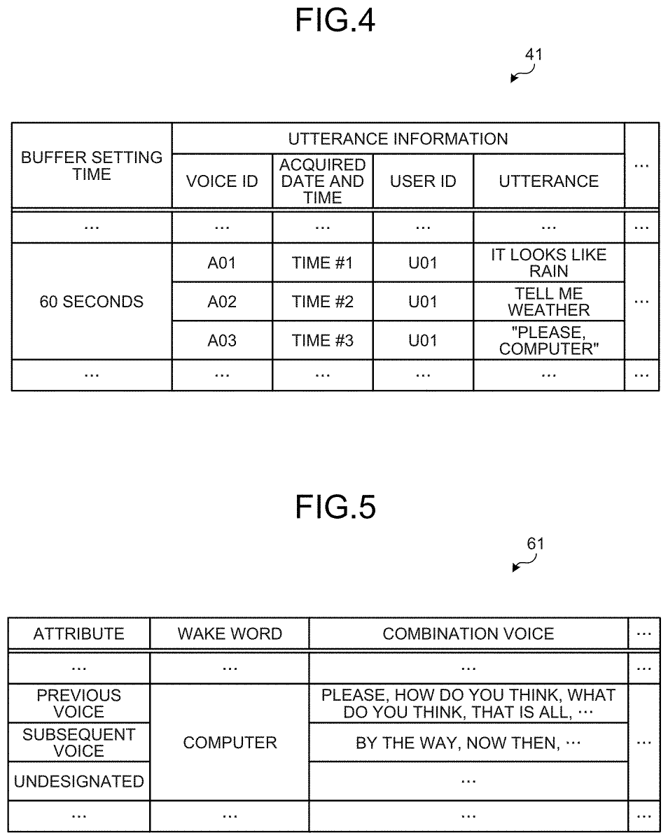

FIG. 4 illustrates an example of the utterance data 41 according to the first embodiment. FIG. 4 is a diagram illustrating an example of the utterance data 41 according to the first embodiment of the present disclosure. In the example illustrated in FIG. 4, the utterance data 41 includes items such as “buffer setting time”, “utterance information”, “voice ID”, “acquired date and time”, “user ID”, and “utterance”.

“Buffer setting time” indicates a time length of the voice to be buffered. “Utterance information” indicates information of the utterance extracted from buffered voices. “Voice ID” indicates identification information for identifying the voice (utterance). “Acquired date and time” indicates the date and time when the voice is acquired. “User ID” indicates identification information for identifying the user who made the utterance. In a case in which the user who made the utterance cannot be specified, the smart speaker 10A does not necessarily register the information of the user ID. The “utterance” indicates specific content of the utterance. For explanation, FIG. 4 illustrates an example in which specific character strings are stored as the items of the utterance, but the information may be stored as the item of the utterance in a mode of voice data related to the utterance or time data for specifying the utterance (information indicating a start point and an end point of the utterance).

In this way, the reception unit 30 may extract and store only the utterance among the buffered voices. That is, the reception unit 30 can receive the voice obtained by extracting only the utterance portion as a voice to be used for a function of interaction processing. Due to this, it is sufficient that the reception unit 30 processes only the utterance that is estimated to be effective for response processing, so that the processing load can be reduced. The reception unit 30 can effectively use the limited buffer memory.

Returning to FIG. 3, the description will be continued. The detection unit 33 detects a trigger for starting the predetermined function corresponding to the voice. Specifically, the detection unit 33 performs voice recognition for the voice corresponding to the predetermined time length as a trigger, and detects the wake word as the voice to be the trigger for starting the predetermined function. The reception unit 30 receives the wake word recognized by the detection unit 33, and transmits the fact that the wake word is received to the interaction processing unit 50.

In a case in which the utterance portion of the user is extracted, the reception unit 30 may receive the extracted utterance portion with the wake word as the voice to be the trigger for starting the predetermined function. In this case, the determination unit 51 (described later) may determine an utterance portion of a user same as the user who uttered the wake word among utterance portions to be the voice to be used for executing the predetermined function.

For example, when an utterance other than that of the user who uttered the wake word is used in a case of making a response using the buffered voice, a response unintended by the user who actually uttered the wake word may be made. Due to this, the determination unit 51 can cause an appropriate response desired by the user to be generated by performing interaction processing using only the utterance of a user same as the user who uttered the wake word among the buffered voices.

The determination unit 51 does not necessarily determine to use only the utterance uttered by a user same as the user who uttered the wake word for processing. That is, the determination unit 51 may determine the utterance portion of a user same as the user who uttered the wake word and the utterance portion of a predetermined user registered in advance among the utterance portions to be the voice to be used for executing the predetermined function. For example, an appliance that performs interaction processing such as the smart speaker 10 may have a function of registering a user for a plurality of people such as a family living in their own house in which the appliance is installed. In a case of having such a function, the smart speaker 10 may perform interaction processing using the utterance before or after the wake word at the time when the wake word is detected even if the utterance is the utterance of the user different from the user who uttered the wake word so long as the utterance is made by a user registered in advance.

As described above, the reception unit 30 receives the voices corresponding to the predetermined time length and the information related to the trigger for starting the predetermined functions corresponding to the voices based on the functions executed by the processing units including the sound collecting unit 31, the utterance extracting unit 32, and the detection unit 33. The reception unit 30 then transmits the received voices and information related to the trigger to the interaction processing unit 50.

The interaction processing unit 50 controls the interaction system as the function of performing interaction processing with the user, and performs interaction processing with the user. The interaction system controlled by the interaction processing unit 50 is started at the time when the reception unit 30 detects the trigger such as the wake word, for example, controls the processing units following the determination unit 51, and performs interaction processing with the user. Specifically, the interaction processing unit 50 generates a response to the user based on the voice that is determined to be used for executing the predetermined function by the determination unit 51, and controls processing of outputting the generated response.

The determination unit 51 determines the voice to be used for executing the predetermined function among the voices corresponding to the predetermined time length in accordance with the information related to the trigger received by the reception unit 30 (for example, the attribute that is set to the trigger in advance).

For example, the determination unit 51 determines a voice uttered before the trigger to be the voice to be used for executing the predetermined function among the voices corresponding to the predetermined time length in accordance with the attribute of the trigger. Alternatively, the determination unit 51 may determine a voice uttered after the trigger to be the voice to be used for executing the predetermined function among the voices corresponding to the predetermined time length in accordance with the attribute of the trigger.

The determination unit 51 may also determine a voice obtained by combining the voice uttered before the trigger and the voice uttered after the trigger to be the voice to be used for executing the predetermined function among the voices corresponding to the predetermined time length in accordance with the attribute of the trigger.

In a case in which the wake word is received as the trigger, the determination unit 51 determines the voice to be used for executing the predetermined function among the voices corresponding to the predetermined time length in accordance with the attribute that is set to each wake word in advance. Alternatively, the determination unit 51 may determine the voice to be used for executing the predetermined function among the voices corresponding to the predetermined time length in accordance with the attribute associated with each combination of the wake word and the voice that is detected before or after the wake word. In this way, for example, the smart speaker 10 previously stores, as definition information, the information related to the setting for performing the determination processing such as whether to use the voice before the wake word for processing or to use the voice after the wake word for processing.

Specifically, the definition information described above is stored in an attribute information storage unit 60 included in the smart speaker 10. As illustrated in FIG. 3, the attribute information storage unit 60 includes combination data 61 and wake word data 62 as a data table.

FIG. 5 illustrates an example of the combination data 61 according to the first embodiment. FIG. 5 is a diagram illustrating an example of the combination data 61 according to the first embodiment of the present disclosure. The combination data 61 stores information related to a phrase to be combined with the wake word, and the attribute to be given to the wake word in a case of being combined with the phrase. In the example illustrated in FIG. 5, the combination data 61 includes items of “attribute”, “wake word”, and “combination voice”.

“Attribute” indicates the attribute to be given to the wake word in a case in which the wake word is combined with a predetermined phrase. As described above, the attribute means a setting for separating cases of timing of the utterance to be used for processing such as “to perform processing by using the voice that is uttered before the wake word in a case of recognizing the wake word”. For example, attributes according to the present disclosure include the attribute of “previous voice”, that is, “to perform processing by using the voice that is uttered before the wake word in a case of recognizing the wake word”. The attributes also include the attribute of “subsequent voice”, that is, “to perform processing by using the voice that is uttered after the wake word in a case of recognizing the wake word”. The attributes further include an attribute of “undesignated” that does not limit the timing of the voice to be processed. The attribute is only information for determining the voice to be used for response generating processing immediately after the wake word is detected, and does not continuously restrict a condition for the voice used for interaction processing. For example, even if the attribute of the wake word is “previous voice”, the smart speaker 10 may perform interaction processing by using a voice that is newly received after the wake word is detected.

“Wake word” indicates a character string recognized as the wake word by the smart speaker 10. In the example of FIG. 5, only one wake word is illustrated for explanation, but a plurality of the wake words may be stored. “Combination voice” indicates a character string by which the attribute is given to the trigger (wake word) when being combined with the wake word.

That is, in the example illustrated in FIG. 5, exemplified is a case in which the attribute of “previous voice” is given to the wake word when the wake word is combined with a voice such as “please”. This is because, in a case in which the user utters “please, computer”, it is estimated that the user has made a request to the smart speaker 10 before the wake word. That is, in a case in which the user utters “please, computer”, the smart speaker 10 is estimated to appropriately answer a request or a demand from the user by using a voice before the utterance.

FIG. 5 also illustrates the fact that, when the wake word is combined with a voice of “by the way”, the attribute of “subsequent voice” is given to the wake word. This is because, in a case in which the user utters “by the way, computer”, it is estimated that the user utters a request or a demand after the wake word. That is, in a case in which the user utters “by the way, computer”, the smart speaker 10 can reduce a processing load by not using the voice before the utterance and performing processing on a voice subsequent thereto. The smart speaker 10 can also appropriately answer a request or a demand from the user.

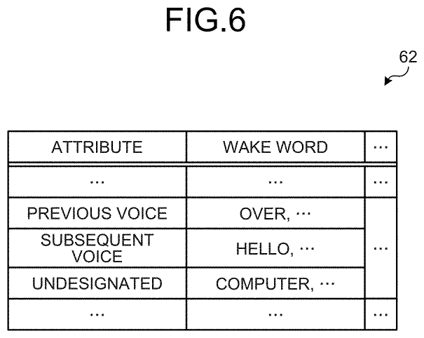

Next, the following describes the wake word data 62 according to the first embodiment. FIG. 6 is a diagram illustrating an example of the wake word data 62 according to the first embodiment of the present disclosure. The wake word data 62 stores setting information in a case in which the attribute is set to the wake word itself. In the example illustrated in FIG. 6, the wake word data 62 includes the items such as “attribute” and “wake word”.

“Attribute” corresponds to the same item illustrated in FIG. 5. “Wake word” indicates the character string recognized by the smart speaker 10 as the wake word.

That is, in the example illustrated in FIG. 6, illustrated is a case in which the attribute of “previous voice” is given to the wake word of “over” itself. This is because, in a case in which the user utters the wake word of “over”, it is estimated that the user has made a request to the smart speaker 10 before the wake word. That is, it is estimated that, in a case in which the user utters “over”, the smart speaker 10 can appropriately answer a request or a demand from the user by using the voice before the utterance for processing.

FIG. 6 also illustrates that the attribute of “subsequent voice” is given to the wake word of “hello”. This is because, in a case in which the user utters “hello”, it is estimated that the user makes a request or a demand after the wake word. That is, in a case in which the user utters “hello”, the smart speaker 10 can reduce the processing load by not using the voice before the utterance and performing processing on a voice subsequent thereto.

Returning to FIG. 3, the description will be continued. As described above, the determination unit 51 determines the voice to be used for processing in accordance with the attribute of the wake word and the like. In this case, in a case of determining the voice that is uttered before the wake word among the voices corresponding to the predetermined time length to be the voice to be used for executing the predetermined function in accordance with the attribute of the wake word, the determination unit 51 may cause a session corresponding to the wake word to end in a case in which the predetermined function is executed. That is, the determination unit 51 can reduce the processing load by causing the session related to interaction to immediately end (more accurately, causing the interaction system to end earlier than usual) after the wake word to which the attribute of previous voice is given is uttered. The session corresponding to the wake word means a series of processing performed by the interaction system that is started triggered by the wake word. For example, the session corresponding to the wake word ends in a case in which the smart speaker 10 detects the wake word, and interaction is interrupted for a predetermined time (for example, one minute, five minutes, and the like) thereafter.

The utterance recognition unit 52 converts, into a character string, the voice (utterance) that is determined to be used for processing by the determination unit 51. The utterance recognition unit 52 may process the voice that is buffered before the wake word is recognized and the voice that is acquired after the wake word is recognized in parallel.

The semantic understanding unit 53 analyzes content of a request or a question from the user based on the character string recognized by the utterance recognition unit 52. For example, the semantic understanding unit 53 refers to dictionary data included in the smart speaker 10 or an external database to analyze content of a request or a question meant by the character string. Specifically, the semantic understanding unit 53 specifies content of a request from the user such as “please tell me what a certain object is”, “please register a schedule in a calendar application”, and “please play a tune of a specific artist” based on the character string. The semantic understanding unit 53 then passes the specified content to the interaction management unit 54.

In a case in which an intention of the user cannot be analyzed based on the character string, the semantic understanding unit 53 may pass that fact to the response generation unit 55. For example, in a case in which information that cannot be estimated from the utterance of the user is included as a result of analysis, the semantic understanding unit 53 passes the content to the response generation unit 55. In this case, the response generation unit 55 may generate a response for requesting the user to accurately utter unclear information again.

The interaction management unit 54 updates the interaction system based on semantic representation understood by the semantic understanding unit 53, and determines action of the interaction system. That is, the interaction management unit 54 performs various kinds of action corresponding to the understood semantic representation (for example, action of retrieving content of an event that should be answered to the user, or retrieving an answer following the content requested by the user).

The response generation unit 55 generates a response to the user based on the action and the like performed by the interaction management unit 54. For example, in a case in which the interaction management unit 54 acquires information corresponding to the content of the request, the response generation unit 55 generates voice data corresponding to wording and the like to be a response. Depending on the content of a question or a request, the response generation unit 55 may generate a response of “do nothing” for the utterance of the user. The response generation unit 55 performs control to cause the generated response to be output from an output unit 70.

The output unit 70 is a mechanism for outputting various kinds of information. For example, the output unit 70 is a speaker or a display. For example, the output unit 70 outputs the voice data generated by the response generation unit 55 by voice. In a case in which the output unit 70 is a display, the response generation unit 55 may perform control of causing the received response to be displayed on the display as text data.

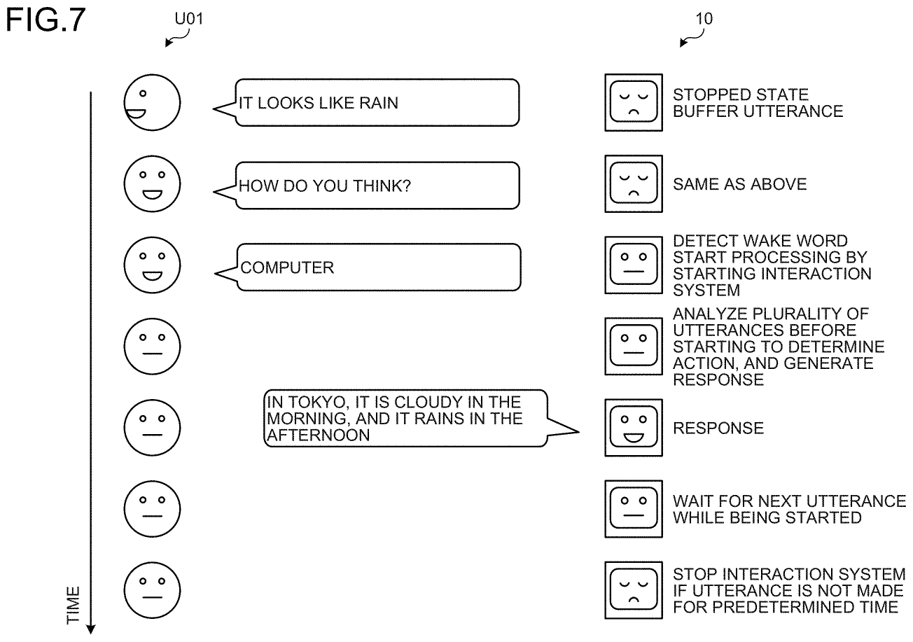

The following specifically exemplifies, with reference to FIG. 7 to FIG. 12, various patterns in which the voice to be used for processing is determined by the determination unit 51, and a response is generated based on the determined voice. FIG. 7 to FIG. 12 conceptually illustrate an interaction processing procedure that is performed between the user and the smart speaker 10. FIG. 7 is a diagram (1) illustrating an example of interaction processing according to the first embodiment of the present disclosure. FIG. 7 illustrates an example in which the attribute of the wake word and the combination voice is “previous voice”.

As illustrated in FIG. 7, even when the user U01 utters “it looks like rain”, the wake word is not included in the utterance, so that the smart speaker 10 maintains a stopped state of the interaction system. On the other hand, the smart speaker 10 continues buffering of the utterance. Thereafter, in a case of detecting “how do you think?” and “computer” uttered by the user U01, the smart speaker 10 starts the interaction system to start processing. The smart speaker 10 then analyzes a plurality of the utterances before starting to determine the action, and generates a response. That is, in the example of FIG. 7, the smart speaker 10 generates the response to the utterance of the user U01, that is, “it looks like rain” and “how do you think?”. More specifically, the smart speaker 10 performs Web retrieval, and acquires weather forecast information or specifies a probability of rain. The smart speaker 10 then converts the acquired information into a voice to be output to the user U01.

After making the response, the smart speaker 10 stands by while keeping the interaction system being started for a predetermined time. That is, the smart speaker 10 continues the session of the interaction system for the predetermined time after outputting the response, and ends the session of the interaction system in a case in which the predetermined time has elapsed. In a case in which the session ends, the smart speaker 10 does not start the interaction system and does not perform interaction processing until the wake word is detected again.

In a case of performing response processing based on the attribute of previous voice, the smart speaker 10 may set the predetermined time during which the session is continued to be shorter than that in a case of the other attribute. This is because, in the response processing based on the attribute of previous voice, the possibility that the user makes the next utterance is lower than that in response processing based on the other attribute. Due to this, the smart speaker 10 can immediately stop the interaction system, so that the processing load can be reduced.

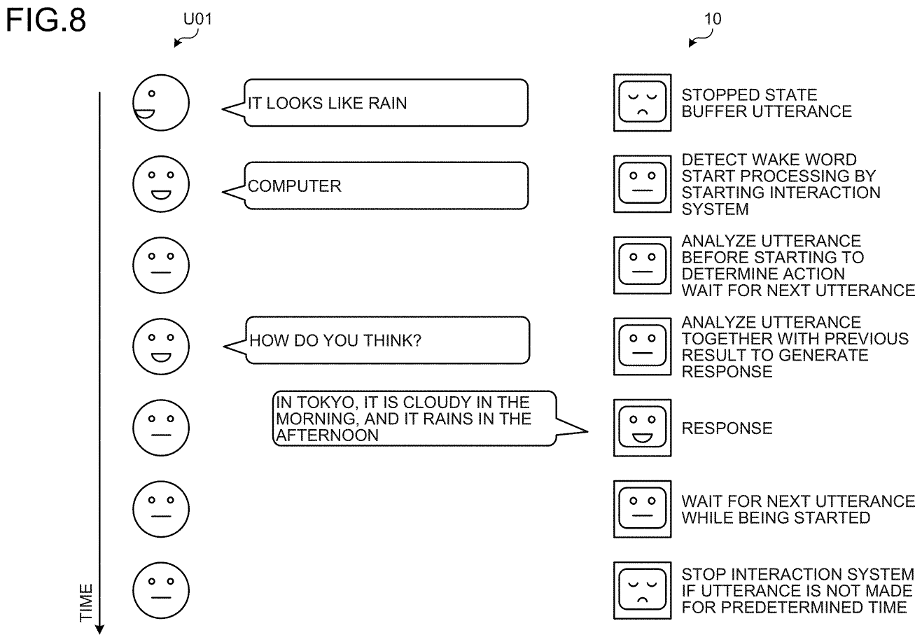

Next, the description will be made with reference to FIG. 8. FIG. 8 is a diagram (2) illustrating an example of interaction processing according to the first embodiment of the present disclosure. FIG. 8 illustrates an example in which the attribute of the wake word is “undesignated”. In this case, the smart speaker 10 basically makes a response to the utterance that is received after the wake word, but in a case in which there is a buffered utterance, generates a response by also using that utterance.

As illustrated in FIG. 8, the user U01 utters “it looks like rain”. Similarly to the example of FIG. 7, the smart speaker 10 buffers the utterance of the user U01. Thereafter, in a case in which the user U01 utters the wake word of “computer”, the smart speaker 10 starts the interaction system to start processing, and waits for the next utterance of the user U01.

The smart speaker 10 then receives the utterance of “how do you think?” from the user U01. In this case, the smart speaker 10 determines that only the utterance of “how do you think?” is not sufficient information for generating a response. At this point, the smart speaker 10 searches the utterances buffered in the voice buffer unit 40, and refers to an immediately preceding utterance of the user U01. The smart speaker 10 then determines to use, for processing, the utterance of “it looks like rain” among the buffered utterances.

That is, the smart speaker 10 semantically understands the two utterances of “it looks like rain” and “how do you think?”, and generates a response corresponding to the request from the user. Specifically, the smart speaker 10 generates a response of “in Tokyo, it is cloudy in the morning, and it rains in the afternoon” as a response to the utterances of “it looks like rain” and “how do you think?” of the user U01, and outputs a response voice.

In this way, in a case in which the attribute of the wake word is “undesignated”, the smart speaker 10 can use the voice after the wake word for processing, or can generate a response by combining voices before and after the wake word depending on the situation. For example, in a case in which it is difficult to generate a response from the utterance that is received after the wake word, the smart speaker 10 refers to the buffered voices, and tries to generate a response. In this way, by combining the processing of buffering the voices and the processing of referring to the attribute of the wake word, the smart speaker 10 can perform flexible response processing corresponding to various situations.

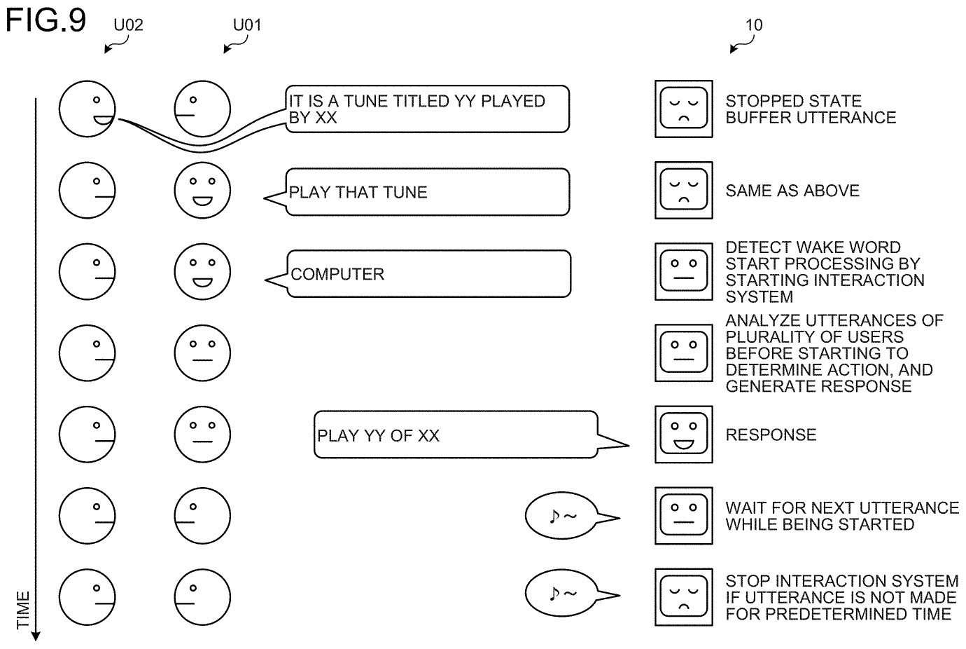

Subsequently, the description will be made with reference to FIG. 9. FIG. 9 is a diagram (3) illustrating an example of interaction processing according to the first embodiment of the present disclosure. In the example of FIG. 9, illustrated is a case in which, even in a case in which the attribute is not set in advance, for example, the attribute is determined to be “previous voice” by combining the wake word and a predetermined phrase.

In the example of FIG. 9, a user U02 utters “it's a tune titled YY played by XX” to the user U01. In the example of FIG. 9, “YY” is a specific title of the tune, and “XX” is a name of an artist who sings “YY”. The smart speaker 10 buffers the utterance of the user U02. Thereafter, the user U01 utters “play that tune” and “computer” to the smart speaker 10.

The smart speaker 10 starts the interaction system triggered by the wake word of “computer”. Subsequently, the smart speaker 10 performs recognition processing for the phrase combined with the wake word, that is, “play that tune”, and determines that the phrase includes a demonstrative pronoun or a demonstrative. Typically, in a case in which the utterance includes a demonstrative pronoun or a demonstrative like “that tune” in a conversation, it is estimated that the object has appeared in a previous utterance. Thus, in a case in which the utterance is made by combining a phrase including a demonstrative pronoun or a demonstrative such as “that tune” and the wake word, the smart speaker 10 determines the attribute of the wake word to be “previous voice”. That is, the smart speaker 10 determines the voice to be used for interaction processing to be “an utterance before the wake word”.

In the example of FIG. 9, the smart speaker 10 analyzes utterances of a plurality of the users before the interaction system is started (that is, the utterances of the user U01 and the user U02 before “computer” is recognized), and determines action related to the response. Specifically, the smart speaker 10 retrieves and downloads the tune “titled YY and played by XX” based on the utterances of “it's a tune titled YY played by XX” and “play that tune”. When reproduction preparation of the tune is completed, the smart speaker 10 makes an output so that the tune is reproduced along with a response of “play YY of XX”. Thereafter, the smart speaker 10 causes the session of the interaction system to be continued for a predetermined time, and waits for an utterance. For example, if feedback such as “No, another tune” is obtained from the user U01 during this time, the smart speaker 10 performs processing of stopping reproduction of the tune that is currently reproduced. If a new utterance is not received during a predetermined time, the smart speaker 10 ends the session and stops the interaction system.

In this way, the smart speaker 10 does not necessarily perform processing based on only the attribute set in advance, but may determine the utterance to be used for interaction processing under a certain rule such as performing processing in accordance with the attribute of “previous voice” in a case in which a demonstrative and the wake word are combined. Due to this, the smart speaker 10 can make a natural response to the response of the user like a real conversation between people.

The example illustrated in FIG. 9 can be applied to various instances. For example, in a conversation between a parent and a child, it is assumed that the child utters “our elementary school has a field day on X month Y date”. In response to the utterance, the parent is assumed to utter “computer, register it in the calendar”. At this point, after starting the interaction system by detecting “computer” included in the utterance of the parent, the smart speaker 10 refers to the buffered voices based on a character string of “it”. The smart speaker 10 then combines the two utterances of “our elementary school has a field day on X month Y date” and “register it in the calendar” to perform processing of registering “X month Y date” as “field day of the elementary school” (for example, registering the schedule in a calendar application). In this way, the smart speaker 10 can make an appropriate response by combining the utterances before and after the wake word.

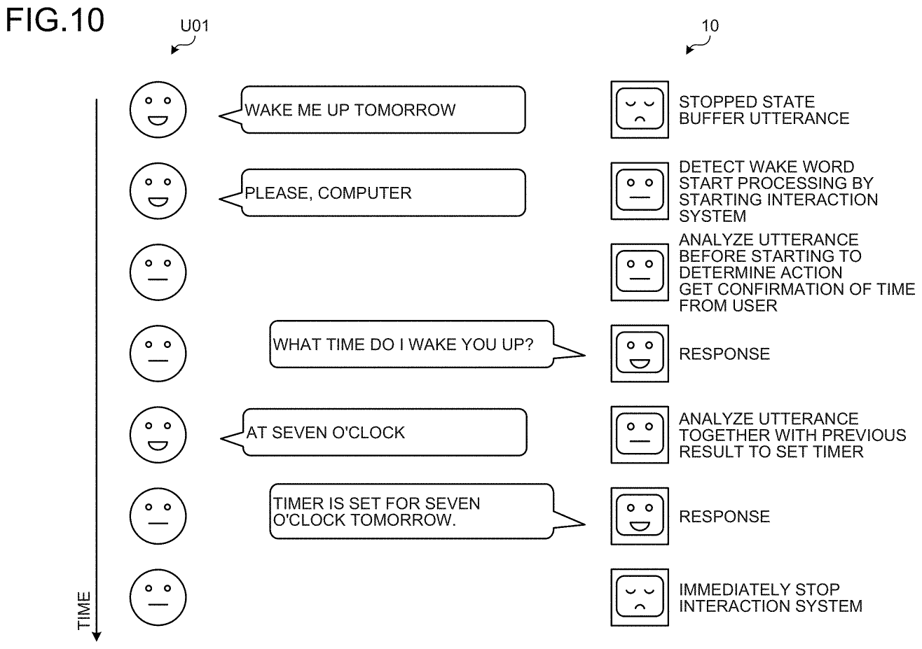

Subsequently, the description will be made with reference to FIG. 10. FIG. 10 is a diagram (4) illustrating an example of interaction processing according to the first embodiment of the present disclosure. In the example of FIG. 10, illustrated is an example of processing that is generated at the time when only the utterance used for processing is insufficient as information for generating a response in a case in which the attribute of the wake word and the combination voice is “previous voice”.

As illustrated in FIG. 10, the user U01 utters “wake me up tomorrow”, and utters “please, computer” thereafter. After buffering the utterance of “wake me up tomorrow”, the smart speaker 10 starts the interaction system triggered by the wake word of “computer”, and starts interaction processing.

The smart speaker 10 determines the attribute of the wake word to be “previous voice” based on the combination of “please” and “computer”. That is, the smart speaker 10 determines the voice to be used for processing to be the voice before the wake word (in the example of FIG. 10, “wake me up tomorrow”). The smart speaker 10 analyzes the utterance of “wake me up tomorrow” before starting, and determines the action.

At this point, the smart speaker 10 determines that only the utterance of “wake me up tomorrow” lacks information about “what time does the user want to wake up” in the action of waking the user U01 up (for example, setting a timer as an alarm clock). In this case, to implement the action of “waking the user U01 up”, the smart speaker 10 generates a response for asking the user U01 a time as a target of the action. Specifically, the smart speaker 10 generates a question of “what time do I wake you up?” to the user U01. Thereafter, in a case in which the utterance of “at seven o'clock” is newly obtained from the user U01, the smart speaker 10 analyzes the utterance, and sets the timer. In this case, the smart speaker 10 may determine that the action is completed (determine that the conversation will be further continued with low probability), and may immediately stop the interaction system.

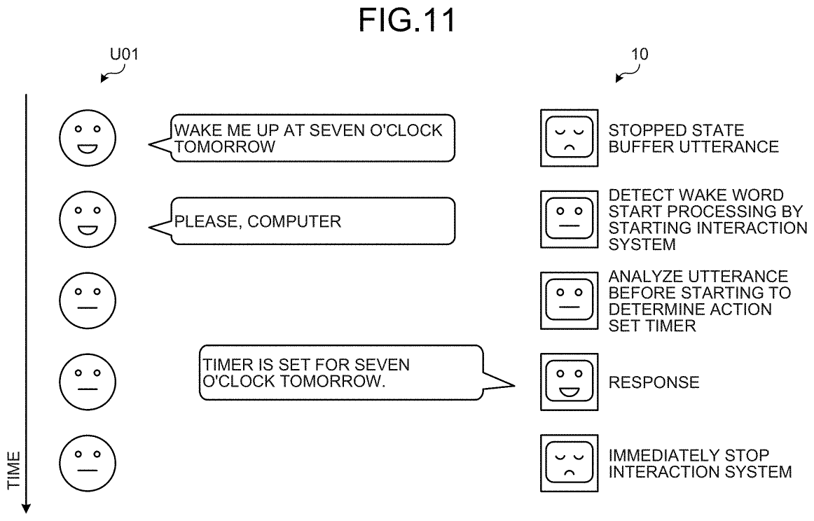

Subsequently, the description will be made with reference to FIG. 11. FIG. 11 is a diagram (5) illustrating an example of interaction processing according to the first embodiment of the present disclosure. In the example of FIG. 11, illustrated is an example of processing that is generated at the time when only the utterance before the wake word is sufficient as the information for generating the response in the example illustrated in FIG. 10.

As illustrated in FIG. 11, the user U01 utters “wake me up at seven o'clock tomorrow”, and utters “please, computer” thereafter. The smart speaker 10 buffers the utterance of “wake me up at seven o'clock tomorrow”, starts the interaction system triggered by the wake word of “computer”, and starts processing.

The smart speaker 10 determines the attribute of the wake word to be “previous voice” based on the combination of “please” and “computer”. That is, the smart speaker 10 determines the voice to be used for processing to be the voice before the wake word (in the example of FIG. 10, “wake me up at seven o'clock tomorrow”). The smart speaker 10 analyzes the utterance of “wake me up tomorrow” before starting, and determines the action. Specifically, the smart speaker 10 sets the timer for seven o'clock. The smart speaker 10 then generates a response indicating the fact that the timer is set, and responds to the user U01. In this case, the smart speaker 10 may determine that the action is completed (determine that the conversation will be further continued with low probability), and may immediately stop the interaction system. That is, in a case of determining that the attribute is “previous voice”, and estimating that the interaction processing is completed based on the utterance before the wake word, the smart speaker 10 may immediately stop the interaction system. Due to this, the user U01 can tell the smart speaker 10 only necessary content, and cause the smart speaker 10 to proceed to a stopped state immediately thereafter, so that time and effort for making an excess response can be saved, and a power supply of the smart speaker 10 can be saved.

The examples of the interaction processing according to the present disclosure have been described above with reference to FIG. 7 to FIG. 11, but the examples are merely an example. The smart speaker 10 can generate responses corresponding to various situations by referring to the buffered voice or the attribute of the wake word in a situation other than that described above.

1-3. Information Processing Procedure According to First Embodiment

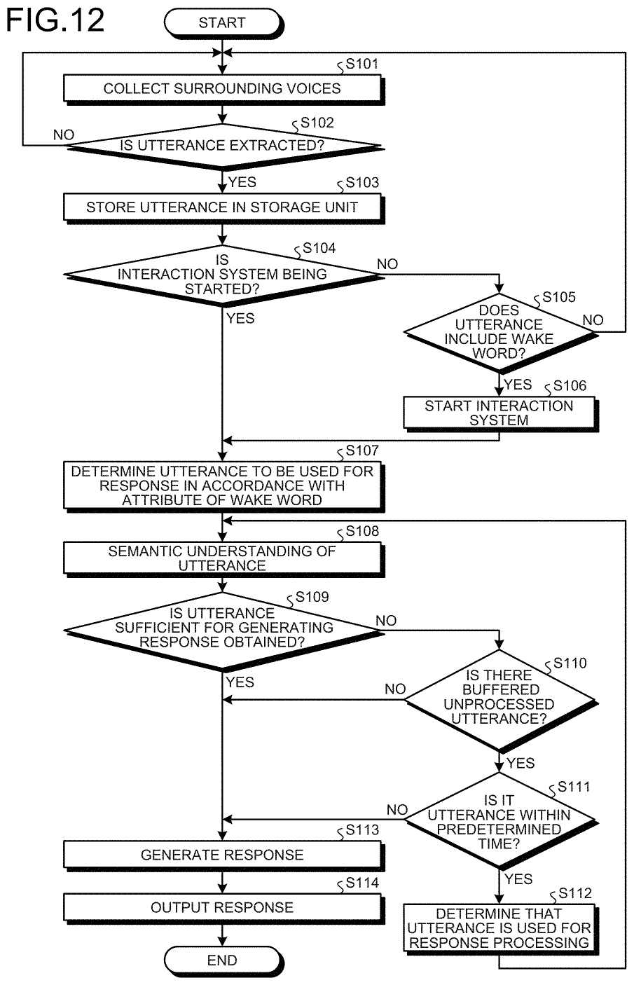

Next, the following describes an information processing procedure according to the first embodiment with reference to FIG. 12. FIG. 12 is a flowchart (1) illustrating a processing procedure according to the first embodiment of the present disclosure. Specifically, with reference to FIG. 12, the following describes a processing procedure of generating a response to the utterance of the user and outputting the generated response by the smart speaker 10 according to the first embodiment.

As illustrated in FIG. 12, the smart speaker 10 collects surrounding voices (Step S101). The smart speaker 10 determines whether the utterance is extracted from the collected voices (Step S102). If the utterance is not extracted from the collected voices (No at Step S102), the smart speaker 10 does not store the voices in the voice buffer unit 40, and continues processing of collecting the voices.

On the other hand, if the utterance is extracted, the smart speaker 10 stores the extracted utterance in the storage unit (voice buffer unit 40) (Step S103). If the utterance is extracted, the smart speaker 10 also determines whether the interaction system is being started (Step S104).

If the interaction system is not being started (No at Step S104), the smart speaker 10 determines whether the utterance includes the wake word (Step S105). If the utterance includes the wake word (Yes at Step S105), the smart speaker 10 starts the interaction system (Step S106). On the other hand, if the utterance does not include the wake word (No at Step S105), the smart speaker 10 does not start the interaction system, and continues to collect the voices.

In a case in which the utterance is received and the interaction system is started, the smart speaker 10 determines the utterance to be used for a response in accordance with the attribute of the wake word (Step S107). The smart speaker 10 then performs semantic understanding processing on the utterance that is determined to be used for a response (Step S108).

At this point, the smart speaker 10 determines whether the utterance sufficient for generating a response is obtained (Step S109). If the utterance sufficient for generating a response is not obtained (No at Step S109), the smart speaker 10 refers to the voice buffer unit 40, and determines whether there is a buffered unprocessed utterance (Step S110).

If there is a buffered unprocessed utterance (Yes at Step S110), the smart speaker 10 refers to the voice buffer unit 40, and determines whether the utterance is an utterance within a predetermined time (Step S111). If the utterance is the utterance within the predetermined time (Yes at Step S111), the smart speaker 10 determines that the buffered utterance is the utterance to be used for response processing (Step S112). This is because, even if there is a buffered voice, a voice that is buffered earlier than the predetermined time (for example, 60 seconds) is assumed to be ineffective for response processing. As described above, the smart speaker 10 buffers the voice by extracting only the utterance, so that an utterance that has been collected long before the predetermined time may be buffered irrespective of the buffer setting time. In this case, it is assumed that efficiency of the response processing is improved by newly receiving information from the user as compared with a case of using the utterance that is collected long ago for processing. Thus, the smart speaker 10 uses the utterance within the predetermined time without using the utterance that is received earlier than the predetermined time for processing.

If the utterance sufficient for generating the response is obtained (Yes at Step S109), if there is no buffered unprocessed utterance (No at Step S110), and if the buffered utterance is not the utterance within the predetermined time (No at Step S111), the smart speaker 10 generates a response based on the utterance (Step S113). At Step S113, the response that is generated in a case in which there is no buffered unprocessed utterance or in a case in which the buffered utterance is not the utterance within the predetermined time may become a response for urging the user to input new information or a response for informing the user of the fact that an answer to a request from the user cannot be generated.

The smart speaker 10 outputs the generated response (Step S114). For example, the smart speaker 10 converts a character string corresponding to the generated response into a voice, and reproduces response content via the speaker.

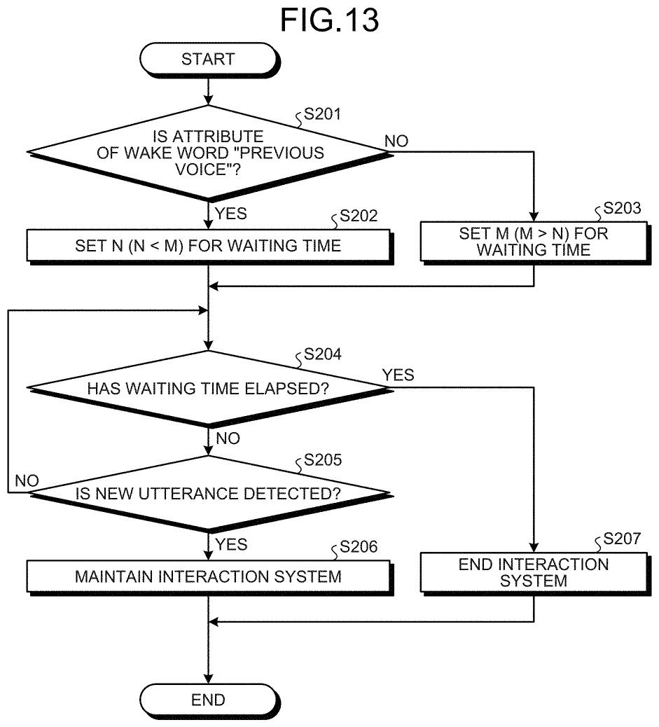

Next, the following describes a processing procedure after the response is output with reference to FIG. 13. FIG. 13 is a flowchart (2) illustrating a processing procedure according to the first embodiment of the present disclosure.

As illustrated in FIG. 13, the smart speaker 10 determines whether the attribute of the wake word is “previous voice” (Step S201). If the attribute of the wake word is “previous voice” (Yes at Step S201), the smart speaker 10 sets, to be N, a waiting time as a time for waiting for the next utterance of the user (Step S202). On the other hand, if the attribute of the wake word is not “previous voice” (No at Step S201), the smart speaker 10 sets, to be M, the waiting time as a time for waiting for the next utterance of the user (Step S203). N and M are optional time lengths (for example, the number of seconds), and a relation of N<M is assumed to be satisfied.

Subsequently, the smart speaker 10 determines whether the waiting time has elapsed (Step S204). Until the waiting time elapses (No at Step S204), the smart speaker 10 determines whether a new utterance is detected (Step S205). If a new utterance is detected (Yes at Step S205), the smart speaker 10 maintains the interaction system (Step S206). On the other hand, if a new utterance is not detected (No at Step S205), the smart speaker 10 stands by until a new utterance is detected. If the waiting time has elapsed (Yes at Step S204), the smart speaker 10 ends the interaction system (Step S207).

For example, at Step S202 described above, by setting the waiting time N to be an extremely low numerical value, the smart speaker 10 can immediately end the interaction system when the response to the request from the user is completed. The setting of the waiting time may be received from the user, or may be performed by a manager and the like of the smart speaker 10.

1-4. Modification According to First Embodiment

In the first embodiment described above, exemplified is a case in which the smart speaker 10 detects the wake word uttered by the user as the trigger. However, the trigger is not limited to the wake word.

For example, in a case in which the smart speaker 10 includes a camera as the sensor 20, the smart speaker 10 may perform image recognition on an image obtained by imaging the user, and detect a trigger from the recognized information. By way of example, the smart speaker 10 may detect a line of sight of the user gazing at the smart speaker 10. In this case, the smart speaker 10 may determine whether the user is gazing at the smart speaker 10 by using various known techniques related to detection of a line of sight.

In a case of determining that the user is gazing at the smart speaker 10, the smart speaker 10 determines that the user desires a response from the smart speaker 10, and starts the interaction system. That is, the smart speaker 10 performs processing of reading the buffered voice to generate a response, and outputting the generated response triggered by the line of sight of the user gazing at the smart speaker 10. In this way, by performing response processing in accordance with the line of sight of the user, the smart speaker 10 can perform processing intended by the user before the user utters the wake word, so that usability can be further improved.

In a case in which the smart speaker 10 includes an infrared sensor and the like as the sensor 20, the smart speaker 10 may detect, as a trigger, information obtained by sensing a predetermined motion of the user or a distance to the user. For example, the smart speaker 10 may sense the fact that the user approaches a range of a predetermined distance from the smart speaker 10 (for example, 1 meter), and detect an approaching motion thereof as a trigger for voice response processing. Alternatively, the smart speaker 10 may detect the fact that the user approaches the smart speaker 10 from the outside of the range of the predetermined distance and faces the smart speaker 10, for example. In this case, the smart speaker 10 may determine that the user approaches the smart speaker 10 or the user faces the smart speaker 10 by using various known techniques related to detection of the motion of the user.

The smart speaker 10 then senses a predetermined motion of the user or a distance to the user, and in a case in which the sensed information satisfies a predetermined condition, the smart speaker 10 determines that the user desires a response from the smart speaker 10, and starts the interaction system. That is, the smart speaker 10 performs processing of reading the buffered voice to generate a response, and outputting the generated response triggered by the fact that the user faces the smart speaker 10, the fact that the user approaches the smart speaker 10, and the like. Through such processing, the smart speaker 10 can make a response based on the voice uttered by the user before the user performs the predetermined motion and the like. In this way, by estimating that the user desires a response based on the motion of the user, and performing response processing, the smart speaker 10 can further improve usability.

### 2. Second Embodiment

2-1. Configuration of Voice Processing System According to Second Embodiment

Next, the following describes the second embodiment. In the first embodiment, exemplified is a case in which the voice processing according to the present disclosure is performed by the smart speaker 10. On the other hand, in the second embodiment, exemplified is a case in which the voice processing according to the present disclosure is performed by the voice processing system 2 including the smart speaker 10A that collects the voices and an information processing server 100 as a server device that receives the voices via a network.

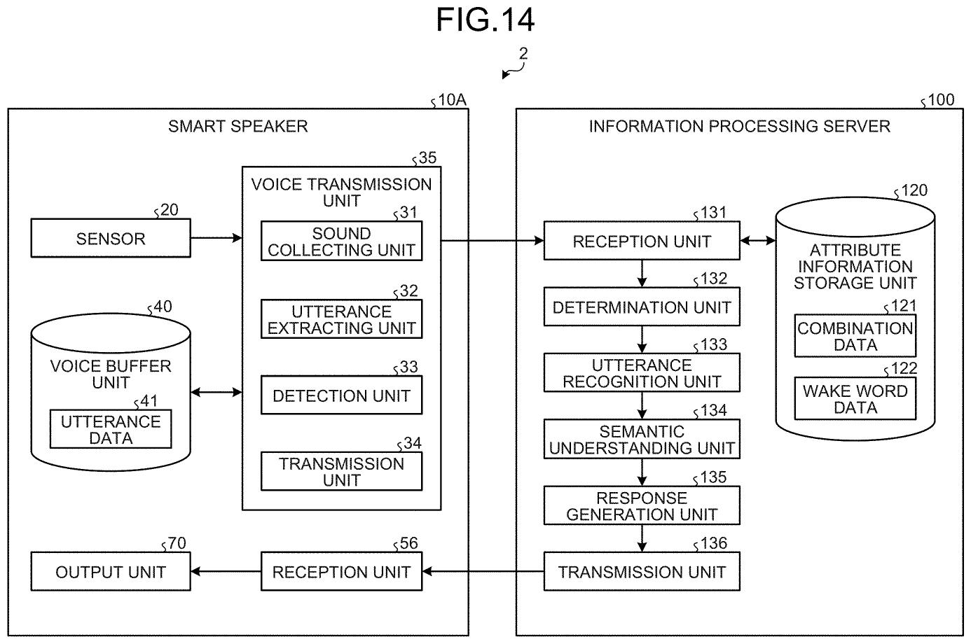

FIG. 14 illustrates a configuration example of the voice processing system 2 according to the second embodiment. FIG. 14 is a diagram illustrating a configuration example of the voice processing system 2 according to the second embodiment of the present disclosure.

The smart speaker 10A is what is called an Internet of Things (IoT) appliance, and performs various kinds of information processing in cooperation with the information processing server 100. Specifically, the smart speaker 10A is an appliance serving as a front end of voice processing according to the present disclosure (processing such as interaction with the user), which is called an agent appliance in some cases, for example. The smart speaker 10A according to the present disclosure may be a smartphone, a tablet terminal, and the like. In this case, the smartphone and the tablet terminal execute a computer program (application) having the same function as that of the smart speaker 10A to exhibit the agent function described above. The voice processing function implemented by the smart speaker 10A may also be implemented by a wearable device such as a watch-type terminal and a spectacle-type terminal in addition to the smartphone and the tablet terminal. The voice processing function implemented by the smart speaker 10A may also be implemented by various smart appliances having an information processing function, and may be implemented by a smart household appliance such as a television, an air conditioner, and a refrigerator, a smart vehicle such as an automobile, a drone, or a household robot, for example.

As illustrated in FIG. 14, the smart speaker 10A includes a voice transmission unit 35 as compared with the smart speaker 10 according to the first embodiment. The voice transmission unit 35 includes a transmission unit 34 in addition to the reception unit 30 according to the first embodiment.

The transmission unit 34 transmits various kinds of information via a wired or wireless network and the like. For example, in a case in which the wake word is detected, the transmission unit 34 transmits, to the information processing server 100, the voices that are collected before the wake word is detected, that is, the voices buffered in the voice buffer unit 40. The transmission unit 34 may transmit, to the information processing server 100, not only the buffered voices but also the voices that are collected after the wake word is detected. That is, the smart speaker 10A does not execute the function related to interaction processing such as generating a response by itself, transmits the utterance to the information processing server 100, and causes the information processing server 100 to perform the interaction processing.

The information processing server 100 illustrated in FIG. 14 is what is called a cloud server, which is a server device that performs information processing in cooperation with the smart speaker 10A. In the second embodiment, the information processing server 100 corresponds to the voice processing device according to the present disclosure. The information processing server 100 acquires the voice collected by the smart speaker 10A, analyzes the acquired voice, and generates a response corresponding to the analyzed voice. The information processing server 100 then transmits the generated response to the smart speaker 10A. For example, the information processing server 100 generates a response to a question uttered by the user, or performs control processing for retrieving a tune requested by the user and causing the smart speaker 10 to output a retrieved voice.

As illustrated in FIG. 14, the information processing server 100 includes a reception unit 131, a determination unit 132, an utterance recognition unit 133, a semantic understanding unit 134, a response generation unit 135, and a transmission unit 136. Each processing unit is, for example, implemented when a computer program stored in the information processing server 100 (for example, a voice processing program recorded in the recording medium according to the present disclosure) is executed by a CPU, an MPU, and the like using a RAM and the like as a working area. For example, each processing unit may also be implemented by an integrated circuit such as an ASIC, an FPGA, and the like.

The reception unit 131 receives a voice corresponding to the predetermined time length and a trigger for starting a predetermined function corresponding to the voice. That is, the reception unit 131 receives various kinds of information such as the voice corresponding to the predetermined time length collected by the smart speaker 10A, information indicating that the wake word is detected by the smart speaker 10A, and the like. The reception unit 131 then passes the received voice and the information related to the trigger to the determination unit 132.

The determination unit 132, the utterance recognition unit 133, the semantic understanding unit 134, and the response generation unit 135 perform the same information processing as that performed by the interaction processing unit 50 according to the first embodiment. The response generation unit 135 passes the generated response to the transmission unit 136. The transmission unit 136 transmits the generated response to the smart speaker 10A.

In this way, the voice processing according to the present disclosure may be implemented by the agent appliance such as the smart speaker 10A and the cloud server such as the information processing server 100 that processes the information received by the agent appliance. That is, the voice processing according to the present disclosure can also be implemented in a mode in which the configuration of the appliance is flexibly changed.

### 3. Third Embodiment

Next, the following describes a third embodiment. In the second embodiment, described is a configuration example in which the information processing server 100 includes the determination unit 132, and determines the voice used for processing. In the third embodiment, described is an example in which a smart speaker 10B including the determination unit 51 determines the voice used for processing at a previous step of transmitting the voice to the information processing server 100.

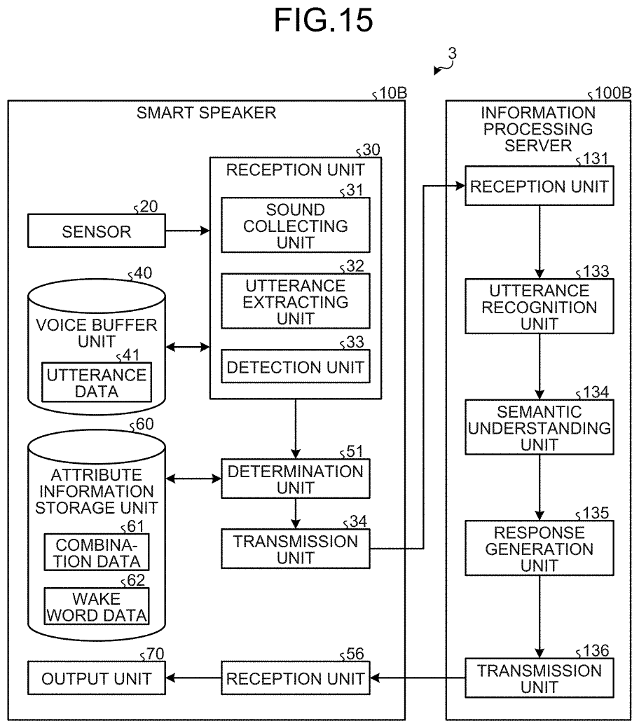

FIG. 15 is a diagram illustrating a configuration example of the voice processing system 3 according to the third embodiment of the present disclosure. As illustrated in FIG. 15, the voice processing system 3 according to the third embodiment includes the smart speaker 10B and an information processing server 100B.

As compared with the smart speaker 10A, the smart speaker 10B further includes the reception unit 30, the determination unit 51, and the attribute information storage unit 60. With this configuration, the smart speaker 10B collects the voices, and stores the collected voices in the voice buffer unit 40. The smart speaker 10B also detects a trigger for starting a predetermined function corresponding to the voice. In a case in which the trigger is detected, the smart speaker 10B determines the voice to be used for executing the predetermined function among the voices in accordance with the attribute of the trigger, and transmits the voice to be used for executing the predetermined function to the information processing server 100.

That is, the smart speaker 10B does not transmit all of the buffered utterances after the wake word is detected, but performs determination processing by itself, and selects the voice to be transmitted to perform transmission processing to the information processing server 100. For example, in a case in which the attribute of the wake word is “previous voice”, the smart speaker 10B transmits, to the information processing server 100, only the utterance that has been received before the wake word is detected.

Typically, in a case in which the cloud server and the like on the network perform processing related to interaction, there is a concern about increase in communication traffic volume due to transmission of the voices. However, when the voices to be transmitted are reduced, there is the possibility that appropriate interaction processing is not performed. That is, there is the problem that appropriate interaction processing should be implemented while reducing the communication traffic volume. On the other hand, with the configuration according to the third embodiment, an appropriate response can be generated while reducing the communication traffic volume related to the interaction processing, so that the problem described above can be solved.

In the third embodiment, the determination unit 51 may determine the voice to be used for processing in response to a request from the information processing server 100B. For example, it is assumed that the information processing server 100B determines that the voice transmitted from the smart speaker 10B is insufficient as the information, and a response cannot be generated. In this case, the information processing server 100B requests the smart speaker 10B to further transmit the utterances buffered in the past. The smart speaker 10B refers to the utterance data 41, and in a case in which there is an utterance with which a predetermined time has not been elapsed after being recorded, the smart speaker 10B transmits the utterance to the information processing server 100B. In this way, the smart speaker 10B may determine a voice to be newly transmitted to the information processing server 100B depending on whether the response can be generated, and the like. Due to this, the information processing server 100B can perform interaction processing by using the voices corresponding to a necessary amount, so that appropriate interaction processing can be performed while saving the communication traffic volume between itself and the smart speaker 10B.

### 4. Other Embodiments

The processing according to the respective embodiments described above may be performed in various different forms other than the embodiments described above.

For example, the voice processing device according to the present disclosure may be implemented as a function of a smartphone and the like instead of a stand-alone appliance such as the smart speaker 10. The voice processing device according to the present disclosure may also be implemented in a mode of an IC chip and the like mounted in an information processing terminal.

The voice processing device according to the present disclosure may have a configuration of making a predetermined notification to the user. This point will be described below by exemplifying the smart speaker 10. For example, the smart speaker 10 makes a predetermined notification to the user in a case of executing a predetermined function by using a voice that is collected before the trigger is detected.

As described above, the smart speaker 10 according to the present disclosure performs response processing based on the buffered voice. Such processing is performed based on the voice uttered before the wake word, so that the user can be prevented from taking excess time and effort. However, the user may be made anxious about how long ago the voice based on which the processing is performed was uttered. That is, the voice response processing using the buffer may make the user be anxious about whether privacy is invaded because living sounds are collected at all times. In other words, such a technique has the problem that anxiety of the user should be reduced. On the other hand, the smart speaker 10 can give a sense of security to the user by making a predetermined notification to the user through notification processing performed by the smart speaker 10.

For example, at the time when the predetermined function is executed, the smart speaker 10 makes a notification in different modes between a case of using the voice collected before the trigger is detected and a case of using the voice collected after the trigger is detected. By way of example, in a case in which the response processing is performed by using the buffered voice, the smart speaker 10 performs control so that red light is emitted from an outer surface of the smart speaker 10. In a case in which the response processing is performed by using the voice after the wake word, the smart speaker 10 performs control so that blue light is emitted from the outer surface of the smart speaker 10. Due to this, the user can recognize whether the response to himself/herself is made based on the buffered voice, or based on the voice that is uttered by himself/herself after the wake word.

The smart speaker 10 may make a notification in a further different mode. Specifically, in a case in which the voice collected before the trigger is detected is used at the time when the predetermined function is executed, the smart speaker 10 may notify the user of a log corresponding to the used voice. For example, the smart speaker 10 may convert the voice that is actually used for a response into a character string to be displayed on an external display included in the smart speaker 10. With reference to FIG. 1 as an example, the smart speaker 10 displays character strings of “it looks like rain” and “tell me weather” on the external display, and outputs the response voice R01 together with that display. Due to this, the user can accurately recognize which utterance is used for the processing, so that the user can acquire a sense of security in view of privacy protection.

The smart speaker 10 may display the character string used for the response via a predetermined device instead of displaying the character string on the smart speaker 10. For example, in a case in which the buffered voice is used for processing, the smart speaker 10 may transmit a character string corresponding to the voice used for processing to a terminal such as a smartphone registered in advance. Due to this, the user can accurately grasp which voice is used for the processing and which character string is not used for the processing.

The smart speaker 10 may also make a notification indicating whether the buffered voice is transmitted. For example, in a case in which the trigger is not detected and the voice is not transmitted, the smart speaker 10 performs control to output display indicating that fact (for example, to output light of blue color). On the other hand, in a case in which the trigger is detected, the buffered voice is transmitted, and the voice subsequent thereto is used for executing the predetermined function, the smart speaker 10 performs control to output display indicating that fact (for example, to output light of red color).

The smart speaker 10 may also receive feedback from the user who receives the notification. For example, after making the notification that the buffered voice is used, the smart speaker 10 receives, from the user, a voice that suggests using a further previous utterance such as “no, use older utterance”. In this case, for example, the smart speaker 10 may perform predetermined learning processing such as prolonging a buffer time, or increasing the number of utterances to be transmitted to the information processing server 100. That is, the smart speaker 10 may adjust an amount of information of the voice that is collected before the trigger is detected and used for executing the predetermined function based on a reaction of the user to execution of the predetermined function. Due to this, the smart speaker 10 can perform response processing more adapted to a use mode of the user.

Among pieces of the processing described above in the respective embodiments, all or part of the pieces of processing described to be automatically performed can also be manually performed, or all or part of the pieces of processing described to be manually performed can also be automatically performed using a well-known method. Additionally, information including processing procedures, specific names, various kinds of data, and parameters that are described herein and illustrated in the drawings can be optionally changed unless otherwise specifically noted. For example, various kinds of information illustrated in the drawings are not limited to the information illustrated therein.

The components of the devices illustrated in the drawings are merely conceptual, and it is not required that the components be physically configured as illustrated necessarily. That is, specific forms of distribution and integration of the devices are not limited to those illustrated in the drawings. All or part thereof may be functionally or physically distributed/integrated in arbitrary units depending on various loads or usage states. The utterance extracting unit 32 and the detection unit 33 may be integrated with each other.

The embodiments and the modifications described above can be combined as appropriate without contradiction of processing content.

The effects described herein are merely examples, and the effects are not limited thereto. Other effects may be exhibited.

### 5. Hardware Configuration

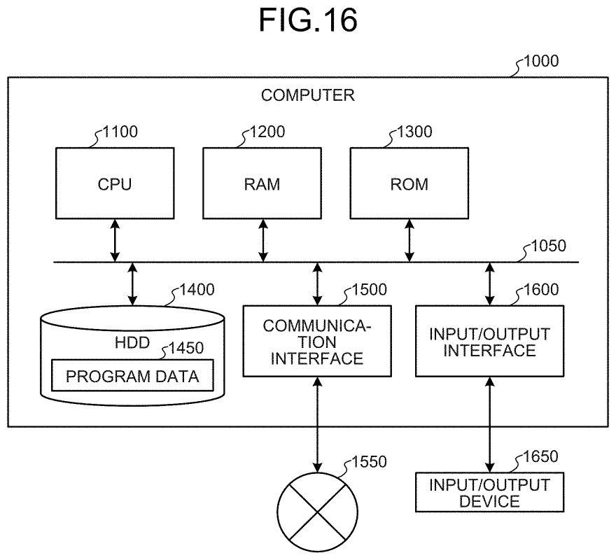

The information device such as the smart speaker 10 or the information processing server 100 according to the embodiments described above is implemented by a computer 1000 having a configuration illustrated in FIG. 16, for example. The following exemplifies the smart speaker 10 according to the first embodiment. FIG. 16 is a hardware configuration diagram illustrating an example of the computer 1000 that implements the function of the smart speaker 10. The computer 1000 includes a CPU 1100, a RAM 1200, a read only memory (ROM) 1300, a hard disk drive (HDD) 1400, a communication interface 1500, and an input/output interface 1600. Respective parts of the computer 1000 are connected to each other via a bus 1050.

The CPU 1100 operates based on a computer program stored in the ROM 1300 or the HDD 1400, and controls the respective parts. For example, the CPU 1100 loads the computer program stored in the ROM 1300 or the HDD 1400 into the RAM 1200, and performs processing corresponding to various computer programs.

The ROM 1300 stores a boot program such as a Basic Input Output System (BIOS) executed by the CPU 1100 at the time when the computer 1000 is started, a computer program depending on hardware of the computer 1000, and the like.

The HDD 1400 is a computer-readable recording medium that non-temporarily records a computer program executed by the CPU 1100, data used by the computer program, and the like. Specifically, the HDD 1400 is a recording medium that records the voice processing program according to the present disclosure as an example of program data 1450.

The communication interface 1500 is an interface for connecting the computer 1000 with an external network 1550 (for example, the Internet). For example, the CPU 1100 receives data from another appliance, or transmits data generated by the CPU 1100 to another appliance via the communication interface 1500.

The input/output interface 1600 is an interface for connecting an input/output device 1650 with the computer 1000. For example, the CPU 1100 receives data from an input device such as a keyboard and a mouse via the input/output interface 1600. The CPU 1100 transmits data to an output device such as a display, a speaker, and a printer via the input/output interface 1600. The input/output interface 1600 may function as a media interface that reads a computer program and the like recorded in a predetermined recording medium (media). Examples of the media include an optical recording medium such as a Digital Versatile Disc (DVD) and a Phase change rewritable Disk (PD), a Magneto-Optical recording medium such as a Magneto-Optical disk (MO), a tape medium, a magnetic recording medium, a semiconductor memory, or the like.

For example, in a case in which the computer 1000 functions as the smart speaker 10 according to the first embodiment, the CPU 1100 of the computer 1000 executes the voice processing program loaded into the RAM 1200 to implement the function of the reception unit 30 and the like. The HDD 1400 stores the voice processing program according to the present disclosure, and the data in the voice buffer unit 40. The CPU 1100 reads the program data 1450 from the HDD 1400 to be executed. Alternatively, as another example, the CPU 1100 may acquire these computer programs from another device via the external network 1550.

The present technique can employ the following configurations.

(1)

A voice processing device comprising:

a reception unit configured to receive voices corresponding to a predetermined time length and information related to a trigger for starting a predetermined function corresponding to the voice; and

a determination unit configured to determine a voice to be used for executing the predetermined function among the voices corresponding to the predetermined time length in accordance with the information related to the trigger that is received by the reception unit.

(2)

The voice processing device according to (1), wherein the determination unit determines a voice that is uttered before the trigger among the voices corresponding to the predetermined time length to be the voice to be used for executing the predetermined function in accordance with the information related to the trigger.

(3)

The voice processing device according to (1), wherein the determination unit determines a voice that is uttered after the trigger among the voices corresponding to the predetermined time length to be the voice to be used for executing the predetermined function in accordance with the information related to the trigger.

(4)

The voice processing device according to (1), wherein the determination unit determines a voice obtained by combining a voice that is uttered before the trigger with a voice that is uttered after the trigger among the voices corresponding to the predetermined time length to be the voice to be used for executing the predetermined function in accordance with the information related to the trigger.

(5)

The voice processing device according to any one of (1) to (4), wherein the reception unit receives, as the information related to the trigger, information related to a wake word as a voice to be the trigger for starting the predetermined function.

(6)

The voice processing device according to (5), wherein the determination unit determines the voice to be used for executing the predetermined function among the voices corresponding to the predetermined time length in accordance with an attribute previously set to the wake word.

(7)

The voice processing device according to (5), wherein the determination unit determines the voice to be used for executing the predetermined function among the voices corresponding to the predetermined time length in accordance with an attribute associated with each combination of the wake word and a voice that is detected before or after the wake word.

(8)

The voice processing device according to (6) or (7), wherein, in a case of determining the voice that is uttered before the trigger among the voices corresponding to the predetermined time length to be the voice to be used for executing the predetermined function in accordance with the attribute, the determination unit ends a session corresponding to the wake word in a case in which the predetermined function is executed.

(9)

The voice processing device according to any one of (1) to (8), wherein the reception unit extracts utterance portions uttered by a user from the voices corresponding to the predetermined time length, and receives the extracted utterance portions.

(10)

The voice processing device according to (9), wherein

the reception unit receives the extracted utterance portions with a wake word as a voice to be the trigger for starting the predetermined function, and

the determination unit determines an utterance portion of a user same as the user who uttered the wake word among the utterance portions to be the voice to be used for executing the predetermined function.

(11)

The voice processing device according to (9), wherein

the reception unit receives the extracted utterance portions with a wake word as a voice to be the trigger for starting the predetermined function, and

the determination unit determines an utterance portion of a user same as the user who uttered the wake word and an utterance portion of a predetermined user that is previously registered among the utterance portions to be the voice to be used for executing the predetermined function.

(12)

The voice processing device according to any one of (1) to (11), wherein the reception unit receives, as the information related to the trigger, information related to a gazing line of sight of a user that is detected by performing image recognition on an image obtained by imaging the user.

(13)

The voice processing device according to any one of (1) to (12), wherein the reception unit receives, as the information related to the trigger, information obtained by sensing a predetermined motion of a user or a distance to the user.

(14)

A voice processing method performed by a computer, the voice processing method comprising:

receiving voices corresponding to a predetermined time length and information related to a trigger for starting a predetermined function corresponding to the voice; and

determining a voice to be used for executing the predetermined function among the voices corresponding to the predetermined time length in accordance with the received information related to the trigger.

(15)

A computer-readable non-transitory recording medium recording a voice processing program for causing a computer to function as:

a reception unit configured to receive voices corresponding to a predetermined time length and information related to a trigger for starting a predetermined function corresponding to the voice; and

a determination unit configured to determine a voice to be used for executing the predetermined function among the voices corresponding to the predetermined time length in accordance with the information related to the trigger that is received by the reception unit.

(16)

A voice processing device comprising:

a sound collecting unit configured to collect voices and store the collected voices in a storage unit;

a detection unit configured to detect a trigger for starting a predetermined function corresponding to the voice;

a determination unit configured to determine, in a case in which the trigger is detected by the detection unit, a voice to be used for executing the predetermined function among the voices in accordance with information related to the trigger; and

a transmission unit configured to transmit, to a server device that executes the predetermined function, the voice that is determined to be the voice to be used for executing the predetermined function by the determination unit.

(17)

A voice processing method performed by a computer, the voice processing method comprising:

collecting voices, and storing the collected voices in a storage unit;

detecting a trigger for starting a predetermined function corresponding to the voice;

determining, in a case in which the trigger is detected, a voice to be used for executing the predetermined function among the voices in accordance with information related to the trigger; and

transmitting, to a server device that executes the predetermined function, the voice that is determined to be the voice to be used for executing the predetermined function.

(18)

A computer-readable non-transitory recording medium recording a voice processing program for causing a computer to function as:

a sound collecting unit configured to collect voices and store the collected voices in a storage unit;

a detection unit configured to detect a trigger for starting a predetermined function corresponding to the voice;

a determination unit configured to determine, in a case in which the trigger is detected by the detection unit, a voice to be used for executing the predetermined function among the voices in accordance with information related to the trigger; and

a transmission unit configured to transmit, to a server device that executes the predetermined function, the voice that is determined to be the voice to be used for executing the predetermined function by the determination unit.

### REFERENCE SIGNS LIST

1, 2, 3 VOICE PROCESSING SYSTEM
10, 10A, 10B SMART SPEAKER
100, 100B INFORMATION PROCESSING SERVER
31 SOUND COLLECTING UNIT
32 UTTERANCE EXTRACTING UNIT
33 DETECTION UNIT
34 TRANSMISSION UNIT
35 VOICE TRANSMISSION UNIT
40 VOICE BUFFER UNIT
41 UTTERANCE DATA
50 INTERACTION PROCESSING UNIT
51 DETERMINATION UNIT
52 UTTERANCE RECOGNITION UNIT
53 SEMANTIC UNDERSTANDING UNIT
54 INTERACTION MANAGEMENT UNIT
55 RESPONSE GENERATION UNIT
60 ATTRIBUTE INFORMATION STORAGE UNIT
61 COMBINATION DATA
62 WAKE WORD DATA

1. A voice processing device comprising:
a reception unit configured to receive voices corresponding to a predetermined time length and information related to a trigger for starting a predetermined function corresponding to the voice; and
a determination unit configured to determine a voice to be used for executing the predetermined function among the voices corresponding to the predetermined time length in accordance with the information related to the trigger that is received by the reception unit.

2. The voice processing device according to claim 1, wherein the determination unit determines a voice that is uttered before the trigger among the voices corresponding to the predetermined time length to be the voice to be used for executing the predetermined function in accordance with the information related to the trigger.

3. The voice processing device according to claim 1, wherein the determination unit determines a voice that is uttered after the trigger among the voices corresponding to the predetermined time length to be the voice to be used for executing the predetermined function in accordance with the information related to the trigger.

4. The voice processing device according to claim 1, wherein the determination unit determines a voice obtained by combining a voice that is uttered before the trigger with a voice that is uttered after the trigger among the voices corresponding to the predetermined time length to be the voice to be used for executing the predetermined function in accordance with the information related to the trigger.

5. The voice processing device according to claim 1, wherein the reception unit receives, as the information related to the trigger, information related to a wake word as a voice to be the trigger for starting the predetermined function.

6. The voice processing device according to claim 5, wherein the determination unit determines the voice to be used for executing the predetermined function among the voices corresponding to the predetermined time length in accordance with an attribute previously set to the wake word.

7. The voice processing device according to claim 5, wherein the determination unit determines the voice to be used for executing the predetermined function among the voices corresponding to the predetermined time length in accordance with an attribute associated with each combination of the wake word and a voice that is detected before or after the wake word.

8. The voice processing device according to claim 7, wherein, in a case of determining the voice that is uttered before the trigger among the voices corresponding to the predetermined time length to be the voice to be used for executing the predetermined function in accordance with the attribute, the determination unit ends a session corresponding to the wake word in a case in which the predetermined function is executed.

9. The voice processing device according to claim 1, wherein the reception unit extracts utterance portions uttered by a user from the voices corresponding to the predetermined time length, and receives the extracted utterance portions.

10. The voice processing device according to claim 9, wherein
the reception unit receives the extracted utterance portions with a wake word as a voice to be the trigger for starting the predetermined function, and
the determination unit determines an utterance portion of a user same as the user who uttered the wake word among the utterance portions to be the voice to be used for executing the predetermined function.

11. The voice processing device according to claim 9, wherein
the reception unit receives the extracted utterance portions with a wake word as a voice to be the trigger for starting the predetermined function, and
the determination unit determines an utterance portion of a user same as the user who uttered the wake word and an utterance portion of a predetermined user that is previously registered among the utterance portions to be the voice to be used for executing the predetermined function.

12. The voice processing device according to claim 1, wherein the reception unit receives, as the information related to the trigger, information related to a gazing line of sight of a user that is detected by performing image recognition on an image obtained by imaging the user.

13. The voice processing device according to claim 1, wherein the reception unit receives, as the information related to the trigger, information obtained by sensing a predetermined motion of a user or a distance to the user.

14. A voice processing method performed by a computer, the voice processing method comprising:
receiving voices corresponding to a predetermined time length and information related to a trigger for starting a predetermined function corresponding to the voice; and
determining a voice to be used for executing the predetermined function among the voices corresponding to the predetermined time length in accordance with the received information related to the trigger.

15. A computer-readable non-transitory recording medium recording a voice processing program for causing a computer to function as:
a reception unit configured to receive voices corresponding to a predetermined time length and information related to a trigger for starting a predetermined function corresponding to the voice; and
a determination unit configured to determine a voice to be used for executing the predetermined function among the voices corresponding to the predetermined time length in accordance with the information related to the trigger that is received by the reception unit.

16. A voice processing device comprising:
a sound collecting unit configured to collect voices and store the collected voices in a storage unit;
a detection unit configured to detect a trigger for starting a predetermined function corresponding to the voice;
a determination unit configured to determine, in a case in which the trigger is detected by the detection unit, a voice to be used for executing the predetermined function among the voices in accordance with information related to the trigger; and
a transmission unit configured to transmit, to a server device that executes the predetermined function, the voice that is determined to be the voice to be used for executing the predetermined function by the determination unit.

17. A voice processing method performed by a computer, the voice processing method comprising:
collecting voices, and storing the collected voices in a storage unit;
detecting a trigger for starting a predetermined function corresponding to the voice;
determining, in a case in which the trigger is detected, a voice to be used for executing the predetermined function among the voices in accordance with information related to the trigger; and
transmitting, to a server device that executes the predetermined function, the voice that is determined to be the voice to be used for executing the predetermined function.

18. A computer-readable non-transitory recording medium recording a voice processing program for causing a computer to function as:
a sound collecting unit configured to collect voices and store the collected voices in a storage unit;
a detection unit configured to detect a trigger for starting a predetermined function corresponding to the voice;
a determination unit configured to determine, in a case in which the trigger is detected by the detection unit, a voice to be used for executing the predetermined function among the voices in accordance with information related to the trigger; and
a transmission unit configured to transmit, to a server device that executes the predetermined function, the voice that is determined to be the voice to be used for executing the predetermined function by the determination unit.
